(19) United States
(12) Patent Application Publication
(10) Pub. No.: US 2008/0052125 A1
(43) Pub. Date: Feb. 28, 2008

(54) PATIENT TRACKING SYSTEMS FOR MAINTAINING THE CONTACT INFORMATION OF ENROLLEES IN A CLINICAL STUDY

(76) Inventors: Melanie Cecilia Bennett, Princeton, NJ (US); Melissa Jane Easy, Richmond (GB); William Douglas Hare, Princeton, NJ (US)

Correspondence Address: WILLIAM DOUGLAS HARE, 3 ANDERSON LANE, PRINCETON, NJ, 08540, US

(21) Appl. No.: 11/845,044

(22) Filed: Aug. 25, 2007

Related U.S. Application Data
(60) Provisional application No. 60/823,647, filed on Aug. 26, 2006.

(51) Int. Cl. G06Q 50/00

(52) U.S. Cl. 705/3

(57) ABSTRACT

One of the inventions relates a method for maintaining the contact information of an enrollee in a clinical study while maintaining the anonymity of the enrollee from the clinical study sponsor. The method includes: (1) obtaining contact information for the enrollee in the clinical study; (2) entering the contact information into a database; (3) using a contact cascade on a scheduled, periodic basis to contact the enrollee using the contact information from the database to ensure that the contact information is correct; and (4) updating the contact information if a contact is made with the enrollee and the contact information needs to be updated to be accurate.

### CROSS-REFERENCE TO RELATED APPLICATIONS

This application claims priority from pending provisional patent application No. 60/823,647, filed on Aug. 26, 2006 and titled Patient Tracking Systems for Maintaining the Contact Information of Enrollees in a Clinical Study, the contents of which are incorporated herein by reference in their entirety.

### TECHNICAL FIELD OF THE INVENTION

The invention is directed, in part, to systems for tracking patients or enrollees who are or have been involved in clinical trials of a pharmaceutical or other medical product and includes a registry that ensures that an enrollee's contact information is kept current on a periodic, scheduled basis and optionally links an enrollee identifier code to an enrollee and that enrollee's location information. The invention also can provide a system that allows the enrollee to remain anonymous to the company sponsoring the clinical trial but allows the sponsor to have two-way contact with the enrollee via the invention, e.g., by email both during and after the study. The invention also relates to a system for protecting the confidentiality of patients who undergo genetic testing or medical testing for other conditions, such as HIV and sexually transmitted diseases, for which they do not want the results known by others who have access to their name and contact details.

### BACKGROUND

The system is designed, in part, to address a problem in clinical studies; that of enrollees being lost to follow up. During a clinical study one or more physicians will interact with a drug or medical device company, a contract research organization, or similar organization to administer a pharmaceutical to an enrollee and track the enrollee and the pharmaceutical's effects on the enrollee. A certain percentage of the enrollees enrolled in the clinical trial, however, will be lost to follow up for various reasons, such as moving away, losing interest in the study, suffering from an illness that is related or unrelated to the study, death that is related or unrelated to the study, etc. This loss of enrollees to follow up creates problems both for the enrollees in the clinical study and the companies relying on the results from the clinical study as they are unable to determine why an enrollee has become lost to follow up and are unable to rule out if it is due to safety, side effects or death as result of the study.

Pharmaceutical and medical device companies conduct clinical studies of new products to determine their safety and efficacy. These clinical studies enroll varying numbers of patients to show safety and efficacy with the number of patients enrolled being determined to provide results having an outcome with a particular statistical significance. Typically, the enrollees are enrolled in a clinical study by a physician acting on behalf of the company, provide retrospective and prospective information about them, take part in the study, and then are subjected to follow up testing or interviews. The data then is used by the company in a submission to the U.S. Food and Drug Administration or other regulatory body.

The patient information, such as name, address and the like, are retained in the files of the physician and generally not provided to the company because of privacy laws, e.g., the Health Insurance Portability and Privacy Act (HIPPA). Thus, the company has very little control over the ability to contact or track the patients enrolled in the study (“the enrollees”) either during, or after, the study except by relying upon the physician or the physician's office staff. This inability to contact the enrollees directly during the study and/or after study completion can create a problem for both the enrollee and the company when the enrollees fail to continue in the study. For instance, the enrollee may need to be contacted about updated information about the study product or protocol. This cannot be readily or consistently accomplished using current methods. Further, for the company, the number of enrollees in the study is determined in advance to achieve a particular statistical result. If there are losses of too many enrollees due to dropping out of the study, that statistical result may not be attained and the resulting outcome may provide only a marginal benefit to the company's objective because they provide limited value in assessing safety and effectiveness. Too great a loss of enrollees may cause regulatory authorities (such as the FDA) to require additional studies or make negative inferences about the outcome, both of which may delay the approval of the product—a significant negative financial result for the company. For example, if too many enrollees fail to continue the study, the FDA may infer that the product caused negative effects and that caused the enrollee to withdraw from the study. Alternatively, a regulatory agency may review the clinical results included in a regulatory submission and decide that the loss of enrollees to follow up causes any outcome not to be statistically significant and thus the regulatory submission must be deemed unapprovable until more data, or at least more complete data, is obtained. In addition to the negative financial consequences, which may contribute to overall drug pricing, any delay in approving a drug will disadvantageously prevent patients from accessing new and useful medicines for treating the conditions from which they suffer.

The problem of enrollee fallout is exacerbated by the inability of the company to contact the enrollees if they do not have the enrollee's contact information. Because drug and medical device companies typically rely on physicians to administer and maintain contact with enrollees, they are unlikely to have enough information about the enrollees in their study to track down lost enrollees and obtain the needed clinical follow up data. Moreover, even if allowed by privacy laws such as HIPPA, most patients are not comfortable providing all their contact and tracking information to directly to a pharmaceutical company that also holds their medical information. Physicians participating in clinical trials typically do not have the administrative resources to follow up and track the enrollees during the clinical trial much less after the clinical trial when it may become even more difficult to follow up and track the enrollees. In particular, the physician's office is ill-equipped to ensure on a regular basis that the enrollee's contact information is kept up-to-date so that the enrollee can be contacted with certainty. For example, the paperwork required for insurance reimbursement and the like may already severely strain the support staff of the physician's office and to include the tracking for a clinical study may not be feasible.

Even if the physician did decide to take on the challenge of tracking the patient on a regular basis, the physician's office may not have the information necessary to do so. As briefly explained above, the physician typically is the party enrolling the patients in clinical studies. The physician generally will record the enrollee's name, social security number, address, and phone number, and rarely the next of kin of the enrollee to contact in an emergency. This may not be enough information to track the patient if they move. And considering that any clinical study may have hundreds to thousands of enrollees and numerous physicians conducting the study, a company faces a significant problem when trying to retain 100% of the enrollees in the study or at least track 100% of the enrollees.

### SUMMARY

In one general aspect there is provided a method for maintaining the contact information of an enrollee in a clinical study while maintaining the anonymity of the enrollee from the clinical study sponsor. The method includes:

obtaining contact information for the enrollee in the clinical study;

entering the contact information into a database;

using a contact cascade on a scheduled, periodic basis to contact the enrollee using the contact information from the database to ensure that the contact information is correct; and

updating the contact information if a contact is made with the enrollee and the contact information needs to be updated to be accurate.

Embodiments of the method may include one or more of the following features. For example, the contact information obtained may include primary contact information and secondary contact information. The secondary contact information may be one or more of contact information for friends, friends who do not live with the enrollee, relative, relatives who do not live with the enrollee, membership in organizations, and an authorization form to contact another entity for information about the enrollee.

Obtaining the contact information for the enrollee in the clinical study may include providing a form that includes a section for providing contact information for the enrollee and at least one placement on the form of a study-patient identifier number. The form may include one or both of a web page for inputting the contact information, an email having a web link, and an email having fields for completing and sending back to the sender.

The method may further include providing a study-patient identifier number for each enrollee and entering the study-patient identifier number into the database.

The database may be maintained on an isolated server. Contacting the enrollee may include retrieving the contact information from the database using a portable storage media, transferring the contact information from the portable storage media to an online computer, and using software to contact the enrollee. Using software to contact the enrollee may include one or more of sending emails to the enrollee, sending text or SMS messages to the enrollee, printing letters and/or mailing addresses to the enrollee, and printing lists of enrollees and telephone numbers for telephoning the enrollees.

The communication cascade may include a sequence of one or more of emails, facsimiles, telephone calls, letters, and text or SMS messages. The communication cascade may be first directed to the primary contact information and then to the secondary contact information.

The method may further include providing a means whereby a sponsor of a clinical study can contact the enrollee or direct a contact to the enrollee while maintaining the anonymity of the enrollee with respect to the sponsor. Contacting the enrollee may include contacting the enrollee by using the study-patient identifier number. Contacting the enrollee by using the study-patient identifier number may include sending an email that includes at least a portion of the study patient identifier number. Contacting the enrollee by using the study-patient identifier number may include using a field on a website that includes the study-patient identifier number to contact the enrollee.

In the method the anonymity of the enrollee from the clinical study sponsor may be maintained when contacting the enrollee. In the method, the contact information of all of the enrollees in the clinical study is maintained in anonymity from the clinical study sponsor.

The method may further include providing a means for the enrollee to communicate to the clinical study sponsor. The method may still further include providing a means for the enrollee to communicate to the clinical study sponsor in response to a communication from the clinical study sponsor. The means of communication may include one or more of a web link, a web page, a text or SMS message, a document, and an email.

In another general aspect there is a form for using in a clinical study to collect contact information of an enrollee in the clinical study. The form includes a first section for providing contact information, a second section for placement of a study-patient identifier number and a third section for placement of an address of a patient tracking service for sending the form to the patient tracking service. Embodiments of the form may include one or more of the features described herein.

In another general aspect there is provided a method for communicating medical information relating to a person while preventing the holder of the medical information from having the patient identifying information with the patient's medical information. The method includes:

providing a medical information request form that does not include patient identifying information but includes a patient identifier number;

providing a means for providing the patient identifying information, wherein the means includes the patient identifier number;

inputting the patient identifying information that is provided into a database;

using the patient identifier number to retrieve the patient identifying information from the database; and

using the patient identifying information retrieved from the database to send the patient medical information to the patient.

Embodiments of the method may include one or more of the following features. For example, the medical information request form may be a listing of medical information required and the patient identifier number. The means for providing the patient identifying information may be a form having the patient identifier number and a section for providing the patient identifying information.

The medical information request form and the means for providing the patient identifying information may be provided together. The medical information request form and the means for providing the patient identifying information may be provided as a single form.

The medical information request form may include requests for at least one test to be performed. The test to be performed may include one or more of a genetic test, a medical test, a disease test, or a screening.

In another general aspect there is a form for requesting a medical test. The form includes:

a first section for specifying a request for medical information;

a second section for providing patient identifying information; and

at least one patient identifier number placed on the form associated with either the first section for specifying the request for medical information or the second section for providing patient identifying information.

Embodiments of the form may include one or more of the following features. For example, the form may further include a second placement of the patient identifier number on the form, wherein at least one patient identifier number placed on the form is associated with the first section for specifying the request for medical information and at least one patient identifier number placed on the form is associated with the second section for providing patient identifying information.

The form may be made up of two unconnected parts and the first part includes the first section for specifying a request for medical information and at least one patient identifier number; and the second part includes the second section for providing patient identifying information and at least one patient identifier number.

The two parts may become unconnected by tearing a perforation formed between the two parts.

The above described features, and many further features, and advantages of the present inventions will be elaborated in the following description and accompanying drawings and claims.

### DESCRIPTION OF THE DRAWINGS

FIG. 1 is a flow chart illustrating the basic steps in an enrollee tracking system engaging in periodic, scheduled updating of enrollee contact information.

FIG. 2 illustrates a patient enrollment form for enrolling in the tracking system of FIG. 1.

FIG. 3 is a flow chart illustrating one implementation of an enrollee tracking system using the patient enrollment form of FIG. 2.

FIG. 4 is a flow chart illustrating a patient contact update cascade for maintaining the contact information of a patient.

FIG. 5 is a flow chart illustrating one implementation of the steps that may be employed to allow a company to directly request information from enrollees who are tracked by the tracking system while maintaining the anonymity of the enrollees to the company.

FIG. 6 is a flow chart illustrating one implementation of a system for enrolling patients in a patient tracking system in which medical and contact information are collected.

FIG. 7 illustrates the enrollment form for enrolling in the patient tracking system of FIG. 6.

FIG. 8 is a flow chart illustrating a method for providing the results of medical and genetic testing to an individual while ensuring that only the individual has both the test results and patient identifying information.

FIGS. 9 and 10 illustrate the front and back sides, respectively, of a form for engaging in the medical and genetic testing of FIG. 8.

### DETAILED DESCRIPTION

The inventors have determined that one means to address the problems described above of clinical study fallout is to develop a system that improves the tracking of the enrollees by increasing the amount of initial information collected, collecting information that is not believed to have been collected to date but improves the ability to find an enrollee, and verifying the contact details of the enrollees on a scheduled, periodic basis. Because of privacy laws, and the privacy concerns of the enrollees, it is unlikely that this system will be implemented by the pharmaceutical or medical device company itself but instead by an independent company or service that performs the patient tracking (defined herein as a patient tracking service or company) on behalf of the company but without providing the enrollees' personal information to the company. One such patient tracking service is Binto USA, Inc. at WWW.BINTO.ORG. As a consequence, the inventors have also determined that there is a benefit to be gained by ensuring that the enrollees have their privacy protected by assigning each enrollee an identifier, e.g., a unique identifier, that, in one implementation, is shared with the company, while not sharing the enrollee's name, such that the company can request that the patient tracking service contact a particular enrollee or all the enrollees in a study. In addition, the enrollee can contact the company without disclosing the enrollee's personal information. In one implementation, the company can contact enrollee by using a communication feature of the patient tracking service to directly or indirectly contact the enrollee while maintaining the anonymity of the enrollee to the company and, optionally, the enrollee can use a communication feature of the patient tracking service to directly or indirectly contact the company while maintaining their anonymity. The details of the inventions are described in more detail below.

As used herein, the terms enrollee and patient are to be viewed synonymously. In some clinical studies (e.g., phase II, III, and IV) an individual may have a condition that is treated by the drug or medical device. In other studies, such as phase I studies, the individual may not have the condition for which the drug or medical device is intended. Patient and enrollee are intended to be applied to both situations. Similarly, the systems described herein are not limited to enrollees or patients in clinical studies. The systems can be applied to keep contact with the investigators in the clinical study. Just as enrollees in clinical studies may move, so too may the investigators. For example, an investigator may move residence as well a leave one practice group to join another group or form a new group. In these events the systems described herein can be used to locate the physician-investigator if the investigator must be contacted during or after the study.

In general, the system for tracking patients addresses the need described above by obtaining a sufficient quantity of primary contact information and secondary contact information that allows the enrollee to be directly contacted or, if they have moved, use the secondary contact information to locate the enrollee. For example, the secondary contact information can be one or more of information such as a social security number, contact information of relative(s), contact information of relative(s) who do not live with the enrollee, contact information of friend(s), contact information of friend(s) who do not live with the enrollee, organizations of which they are a member, and an authorization to contact a credit agency for the sole purpose of updating contact information on that enrollee (but not to see the credit report or receive the credit report with information other than contact information).

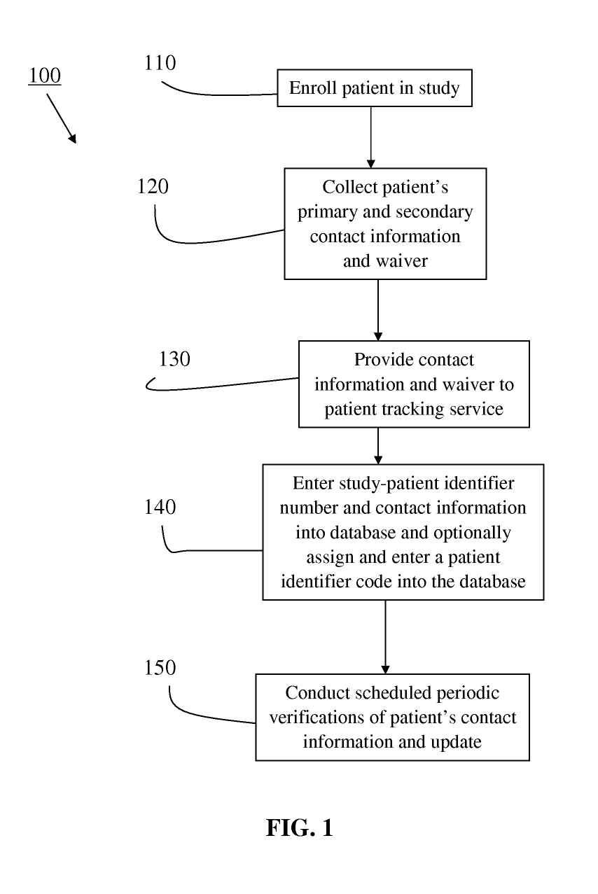

Referring to FIG. 1, in one basic implementation, a patient tracking system 100 can be implemented with the following steps. First, in a clinical study a patient is enrolled (step 110). Following or concurrently with enrollment, the patient provides primary contact information and secondary contact information and optionally a waiver for collection and/or dissemination of information and to be contacted for registering in a clinical study (step 120). The contact information and waiver is then provided for input into the system (e.g., a database or other computer readable medium) (step 130) in the control of the patient tracking service. The information then is entered into the system (step 140). Steps 130 and 140 may be combined into a single step. For example, upon receipt of the information by the patient tracking service, the service may assign, either manually or electronically, an identifier code and that number entered into the system as well as placed on the form. The system then contacts or is used to contact the enrollees to verify their contact information (step 150). The contact is made on a scheduled or at least periodic basis and may be on a scheduled, periodic basis. An initial contact at enrollment also may be made to verify not only the contact information, but to verify that the enrollee wishes to register with the system. This initial contact may be made before or after the contact information is entered into the database. The system 100 and the various steps involved are provided in more detail below.

As used herein, scheduled means that there is a mechanism to contact the enrollee on a set schedule to keep the contact information current and correct. On the other hand, periodic means that the enrollee is contacted, for example, on a periodic basis, which may be whenever they determine that the contact information is no longer accurate, to keep the contact information current and correct. Thus, a scheduled, periodic basis means that there is a preset (i.e., periodic) schedule for contacting the enrollee but that it may be more frequent if the enrollee's contact information is otherwise found to be incorrect or not longer current.

The collection of both the patient's primary and secondary contact information (step 120) provides a backup method if the patient moves away and thus the patient tracking service no longer has current contact information for that enrollee. For example, if the patient only provides their address and telephone number for a LAN line, if they move away the address will certainly change and the telephone number likely will also change. However, if a sufficiently broad range of secondary contact information is obtained upon enrollment, even if the enrollee moves away, the secondary information can be used to increase the likelihood that the enrollee will be eventually contacted. Examples of secondary contact information include the names, addresses and telephone numbers of relatives, close friends, and people (e.g., friends and family) not living with the enrollee who are likely to know where the enrollee can be found. Other secondary contact information that can be used includes social security number, email addresses, and organizations of which the enrollee is a member (e.g. trade and professional associations, clubs, etc.) and may be on a mailing list.

Finally, the collection of information can be supplemented with a signed waiver or authorization form that allows the patient tracking service to contact a credit agency and obtain an address from the credit agency. With this waiver or authorization form, the tracking organization should be able to obtain a current address for the enrollee. An additional waiver or authorization form also can be used to grant permission to contact organizations of which the enrollee is a member and obtain a current address. In addition, the enrollee can sign an authorization form that grants the patient tracking service the permission to telephone or otherwise attempt to contact the enrollee. This authorization form is in recognition that do-not-call lists exist and enrollees may have their names on the list. The authorization form is intended, in part, to prevent liability from using the telephone to contact enrollees. Finally, or separately, the patient tracking form 230 may include an option of consenting to be contacted by the patient tracking service to be informed about participating in clinical studies.

The contact information and waiver is then provided for input into the system (e.g., a database or other computer readable medium) (step 130) in the control of the patient tracking service. The information then is entered into the system (step 140) and an optional identifier code is assigned to the patient's form 160. Steps 130 and 140 may be combined into a single step. For example, upon receipt of the information by the patient tracking service, the service may assign, either manually or electronically, an identifier code and that number entered into the system as well as placed on the form. The identifier may be pre-printed on a form that is given to the patient to enroll in the service. The system then contacts or is used to contact the enrollees to verify their contact information. The contact is made on a scheduled or at least periodic basis and may be on a scheduled, periodic basis. The system 100 and the various steps involved are provided in more detail below.

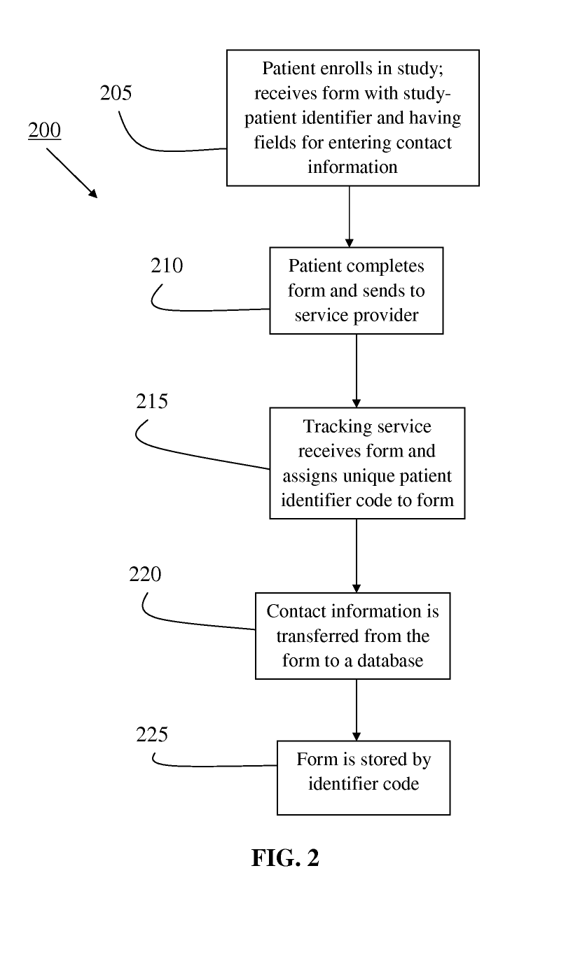

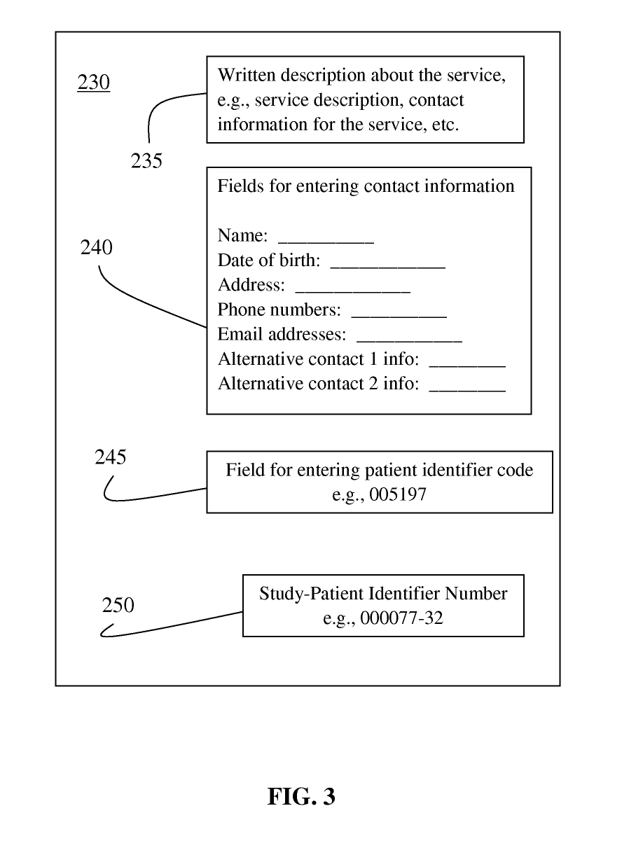

Referring in greater detail to FIGS. 2 and 3, in one implementation of a method 200 for operating a patient tracking service, a patient enrolls in a study (step 205) and receives a patient enrollment form 230 for registering in the patient tracking service. As illustrated in detail in FIG. 3, the patient enrollment form 230 includes fields for a description of the service 235, fields for contact information 240, fields for adding a patient identifier code 245 and a field for placement of a study-patient identifier number 250. The reverse side of the enrollment form 230 may include the mailing address of the patient tracking service for sending the completed form to the service.

The description of the patient tracking service may provide information about the objectives of the service, how the service functions, its privacy policy and other information of use to the enrollee. The description 235 also may include contact information, such as telephone numbers, facsimile numbers, email addresses, and postal addresses for contacting the service.

The contact information 240 provides fields for entry of primary and secondary contact information and details, such as name, date of birth, address, phone numbers, email addresses, postal addresses, and any other useful, additional contact information. The fields for entering the data should be of sufficient size to allow complete and easy entry of the required information onto the form. The secondary contact information provides information such as social security number, next of kin information, organizational memberships, employers, and the like. Secondary contact information also can include contact information for people who live or don't live with the enrollee. For example, if the secondary contact information is for someone who does not live with the enrollee, the likelihood of the alternative contact moving at the same time as the enrollee is less than if the alternative contact lives with the enrollee. Thus, using an alternative contact not living with the enrollee increases the likelihood that the enrollee can be found if the enrollee should move from the address used at the time of enrollment.

The patient identifier code 245 is an optional number that may be used to correlate the stored hard copy of the information with that in the database. For example, the patient identifier code may be placed on the hard copy form using a stamp or a sticker. This is useful if the hard copy of the information is stored sequentially and there is a later need to verify or otherwise look at information on the form as received. One important aspect of the patient identifier code 245 is that the system should be able to distinguish between enrollees in different studies operated by different entities or the same entities. This aspect is in recognition of the privacy concerns associated with clinical studies and the need to maintain patient anonymity, e.g., to prevent mixing up enrollees and providing one enrollee from one study with the personal information from another enrollee in a different study. Providing a sequentially increasing code is one means to have unique identifiers to prevent patient mix up.

The study-patient identifier number 250 is a number, letter, or series of numbers and/or letters that is shared by the patient tracking service and the CRO or drug company. Although termed a study-patient identifier number, the number 250 does not need to be directly connected to a particular study. Similarly, the use of the term number should not be construed to limit to a number as any alphanumeric character can be used. The identifier number 250 can be assigned to each enrollee or to each form. For example, each form can be printed with the placement of the study-patient identifier number on the form. Thus, each form will differ from another by the placement of the study-patient identifier number.

The identifier number can be assigned by the patient tracking service, the investigator, the contract research organization managing the clinical study, or the company whose product is the subject of the clinical study. For example, the contract research organization or the company may have their own enrollee identification system consisting of alphanumeric characters already in place and used by the company to identify enrollees, although not necessarily by name. This already-existing identification system or identifier can be used by the patient tracking service to better serve the contract research organization or company because the study-patient identification number will function in the company's existing system. Alternatively, the patient tracking service can assign its own study-patient identification number. For example, the drug company may wish to use an identifier that relates to their internal study identifier as well as the investigator and patient. Thus a Pfizer study may be internally assigned the code PF07RBX, the investigators may be assigned the numbers 01-40 for the study and each investigator may have the ability to enroll up to 99 patients. Thus, for this study patient 74, enrolled by investigator 37 would be assigned the identifier number PF07RBX37-74. FIG. 3 illustrates a more simple example where the study sponsor may allow the patient tracking service to specify the identifier number 250. This number may repeat between studies.

The enrollment process of step 205 may be conducted by or at a hospital, doctor, site or other center participating in the study. Typically a physician will be the investigator conducting a study for a contract research organization (CRO) on behalf of a drug or medical device company. However, for purposes of the system 100, the entity involved in the study and enrolling the patient is not intended to be limited to either hospitals, doctors, CROs, etc. but is to be broadly interpreted to encompass any entity enrolling a patient in a study. In the clinical study enrollment process the investigator provides the patient a package of information relating to the study, including a description of the study, informed consent forms, and a schedule for events relating to the clinical study. As part of the process 200, the investigator also will provide the patient tracking form 230 to the patient for completing and sending to the patient tracking service.

It should be noted that the patient tracking form 230 can be implemented in a number of embodiments, for example, as a paper form, a webpage, an email, or other form of communication. For example, the enrollee can be directed to a webpage, open a secure link and enter their contact information. The webpage then assigns a study-patient identifier number and causes a form to be printed out with the study-patient identifier number and the contact information placed or printed on the form. This can be sent to the patient tracking service using the postal service. Alternatively, the information can be provided or submitted electronically to the patient tracking service.

Upon collection of the primary and secondary contact information by the patient, physician, hospital, or other investigator, or entity other than the patient tracking service, which is likely to be the most typical scenario for providing the patient tracking form 230, the information then is provided to the patient tracking service (step 210). In general, because of patient privacy concerns and HIPPA, the information likely will be directly entered by the enrollee on the patient tracking form and submitted to the tracking service by the patients, rather than the information being collected, entered, and submitted by the investigator to the patient tracking service. Of course, as privacy laws change, it is expected that these arrangements may vary but it is expected that providing, completing, and submitting information forms will be in accord with privacy laws and concerns. Thus, for example, in one implementation the physician can be provided the uncompleted patient tracking forms and then pass them on to the enrollee. The enrollee then completes the form, places the form in an addressed envelope and seals the envelope (alternatively, the form is self-addressed and posted without the need for a separate envelope) and sends the envelope to the patient tracking service. Alternatively, the enrollee may provide the completed form to the physician for forwarding on to the patient tracking service. In most cases, however, it will be the enrollee who enters into a relationship with the patient tracking service.

The information can be provided to the patient tracking service in the form of any media. For example, the information can be provided merely in paper form, e.g., the forms completed by the enrollee or the investigator, or in electronic form (e.g., facsimile, email, CD, DVD, database, weblink, etc.). The invention is not limited by the means in which the primary and secondary contact information is transmitted or otherwise provided to the patient tracking organization. It is contemplated that regardless of the means by which the information is provided to the patient tracking service, in one implementation the information will be printed out, processed, and stored both electronically and in hard copy as if the information was provided initially only on a paper form. In other implementations, the information can be processed all in a paperless manner.

In the case where the information is provided as a paper copy of a patient tracking form 230, the form may be initially stamped or otherwise affixed with the patient identifier code 245 (step 215). For example, the patient identifier code may be a sequentially increasing number, letter, character, or mixture of the three. The identifier code may be used for storing paper copies of the forms and/or information in a filing system for later retrieval, if needed. As noted above, the study-patient identifier number 250 may repeat and thus cannot easily be used as the basis for a simple method of storing hard copy versions of the information. When the identifier code 245 is used, it can be unique and form the basis for connecting the information in the database to the information in the filing system (step 225).

The patient identifier code 245, study-patient identifier number 250, primary and secondary contact information 240 optionally may be entered into a database or other organization data management system (step 220). In this manner, the primary and secondary contact information of all the enrollees can be kept and maintained in an efficient manner. This database or data management system will have the contact information for all of the enrollees in a study, not just of the enrollees of one investigator. Thus, the contact information is collected across the entire breadth of the study, e.g., all investigators, all sites, etc.

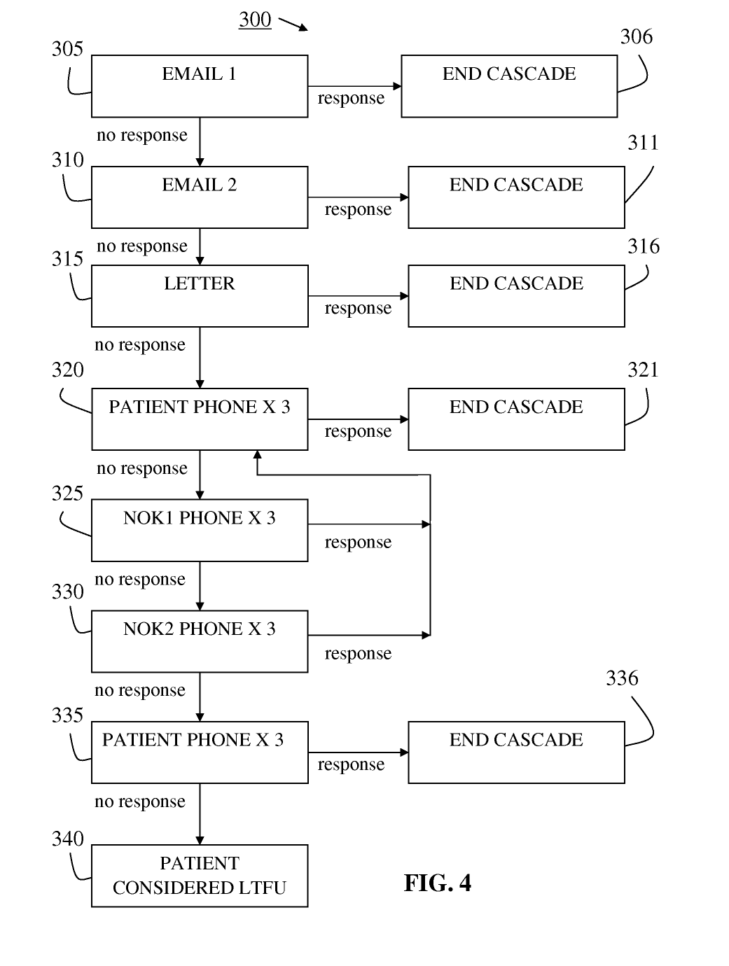

Referring to FIG. 4, once the enrollee contact information has been entered into the database, in a process 300 the tracking system is maintained and kept current by contacting enrollees on a periodic and/or scheduled basis to ensure that the contact information is current. The periodicity and scheduling of the contact may be varied depending upon the study needs, nature of the product tested, or as otherwise requested by the contract research organization or company. For example, the contract research organization may require that the enrollees' contact information be verified every six months for only two years. Alternatively, if the product is a pharmaceutical to treat a chronic condition, and is expected to be taken for a lengthy duration, then the requirement for updating may be annually but without a limit to the duration of updating. The company may also want the contact information updated if it is determined that the contact information is no longer correct or accurate.

A number of different contact sequences or contact cascades can be used to contact the patient. For example, the patient can be contacted by telephoning, emailing, faxing, and mailing. If those are unsuccessful, the patient tracking service can use the secondary contact information, such as next of kin. In one cascade, two emails (steps 305, 310) are sent to the patient's email addresses that were given upon enrollment or subsequent updating. If these emails contacts are successful, the patient responds, and the contact information is updated, the cascade ends (steps 306, 311). It should be noted that a number of contact methods have been specified above for contacting the patient. These methods are exemplary only and other communications methods can be used, such as SMS, text messaging, a message on a personalized, secure web page or web account, etc.

If there is no response to either of the emails, the patient tracking service sends out a letter to the patient (step 315). If the patient responds and the contact information is updated, the cascade ends (step 316). It should be noted that the inventors anticipate that the system can be configured to send out one, two, three or more emails in the cascade to maintain contact with the patient. Further, the emails can be sent on a daily basis, or more or less frequently, and the subsequent letter can be sent out immediately after the email is sent or at a period afterwards. The timing can be agreed upon with the company sponsoring the clinical study or specified by the tracking service based on past experience and the optimal timing. If the patient provides multiple email addresses, the service can be used to send the information to each email address one or more times.

If there is no response to the letter, the patient tracking service uses a series of telephone calls to try to contact the patient (step 320). The telephone calls can be set to be made at different times during the day to increase the likelihood that the patient will be contacted if they have a set schedule they maintain, for example, their work schedule. If the patient responds and the contact information is updated, the cascade ends (step 321).

If there is no response to the series of telephone calls (step 320), the patient tracking service uses a series of next of kin or alternative contacts' telephone calls (steps 325, 330) to try to contact the patient's alternative contacts. The telephone calls can be set to be made at different times during the day to increase the likelihood that the alternative contacts will be contacted if they have a set schedule they maintain, for example, their work schedule. If the alternative contact responds, that information can be used to contact the patient and update the contact information and end the cascade (step 321). If there is no response to the telephone calls to the alternative contacts, the patient is considered lost to follow up (step 340).

As another objective, the company may decide that to reduce legal liabilities associated with a pharmaceutical or medical product, the contact information should be updated annually without a limit to the duration of updating so that the enrollees can be easily contacted to verify the absence of long term adverse effects. For example, if a tort litigation is brought over a product, a drug company can use the results of the tracking service to contact the original patients enrolled in the clinical studies used to approve the drug. These enrollees will have had the exposure to the drug before those later taking the drug. If it can be shown that the occurrence of an adverse event (e.g., stroke, heart attack) occurs with equal frequency in the general population as in those who initially were administered the drug, then that is compelling evidence that a later suggestion attributing an adverse event to the drug may be misplaced.

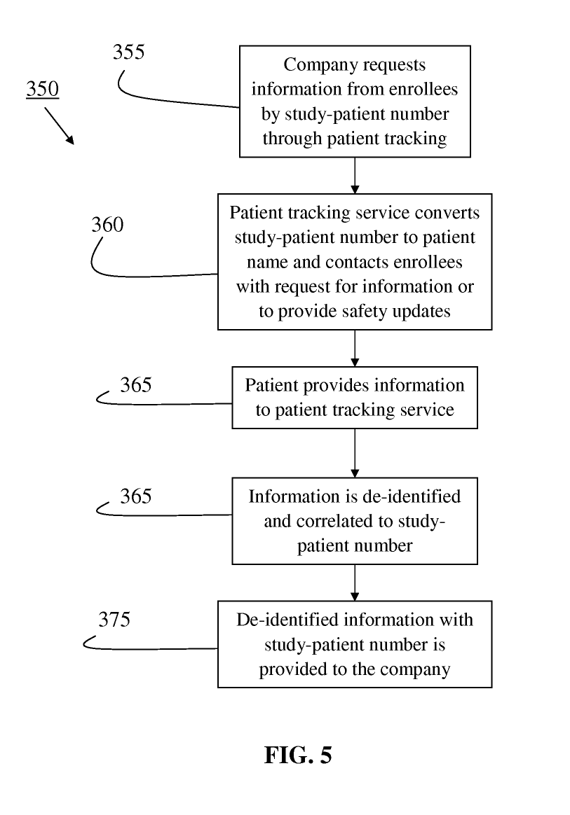

Based on the above scenarios, the tracking system can have an additional function of contacting enrollees to provide and/or obtain safety information and substantive information relating to the clinical study in which they were enrolled. Referring to FIG. 5, the tracking system can have an additional function 350 that allows the company sponsoring the clinical trial (or designee, e.g., contact research organization) to contact the patient tracking service, or the system itself, and request that information be provided to, or obtained from, the enrollee or company (step 355). For example, years after a pharmaceutical product has been approved, the pharmaceutical company may learn of a safety concern and desire to communicate that information to the enrollee. The company may additionally or independently seek to learn whether any patients in any part of the study (e.g., the phase II or III trials) of the pharmaceutical have had any adverse cardiovascular events (e.g., stroke, heart attack) that may be associated with the product.

To obtain this information, the company can contact (step 355) the system by merely specifying the study-patient identifier number. With the study-patient identifier number, the tracking system converts that number into either the patient identifier code and then determines the patient's contact information, or directly converts the identifier number into the contact information. The tracking system then uses the contact information to contact those enrollees with the specified study-patient identifier numbers and provide the safety information and/or request the sought-after information (step 360). If the communication is to obtain information from the patient, the information can be provided to the patient tracking service over the telephone, by email, etc. (step 365). Once that information has been obtained, this information is de-identified of any patient identifying information, optionally associated with the study-patient identification number and then can be provided to the company as-is or after further processing and analysis (375).

The contact between the company, the patient and the tracking system can occur through a variety of means. For example, the tracking system can be configured such that the company merely sends an email to the tracking service is in a format that includes the patient identifier code as the local part and the tracking organization as the domain (e.g., 1234.XYZ@trackingorganization.com in the form of localpart@domain.example) and the tracking system directly or indirectly forwards that email to the patient. Alternatively, the tracking organization can have a secure website that allows the company to enter or click on one or more patient identifier codes and cause those enrollees to be contacted. Such a website could allow the company to contact all of the enrollees in the study by clicking a single button or allow the company to selectively contact enrollees based on demographics of the particular enrollees. For example, the company may seek to determine the accuracy of an assertion in a lawsuit that overweight males older than 55 years have an increased likelihood of bladder cancer if they have taken the particular drug that was the subject of the study. The company can use the demographics of the enrollees, which would include the identifier code, and choose to contact only those enrollees who meet that criteria. In another implementation, the company or sponsor sends an email to the tracking service with a listing of study-patent identifier numbers and instructions as to what type of contact must be made, e.g., a safety update.

If the email from the company has made a request that the enrollee provide information to the company, the system can be configured to allow the patient to respond to the company with the information. Numerous implementations can be used to provide this function and ensure enrollee anonymity of the response. For example, using the implementation described above, the company sends an email in which there the “localpart” of the email address is the patient identifier but upon receipt by the tracking organization, the resulting email is sent to the enrollee using the enrollee's personal email address. However, to reply to the tracking organization and ultimately the company, the enrollee can use the “reply” button on the computer or open a link in the email that provides a page for entering information. In either event, the email that is sent to the company, if that is the form of communication to be used, will have the local part once again being the patient identifier code and the domain being the tracking organization. Thus, to the company, it will appear to be a direct response from the enrollee while in actuality the enrollee's privacy has been maintained without diminishing the validity of the information transmitted from the company to the enrollee and back from the enrollee to the company.

In another implementation, the system can be configured to have the ability to store the drug name, batch number provided to each enrollee, drug code number of the drug provided to the enrollee and other information. In general, this information is of the type that may be useful in conveying safety information to the enrollee and allowing one or more enrollees to be distinguished from amongst a larger set of enrollees based on what they were administered. In this manner, the tracking organization can have the system configured to allow the company to contact those enrollees who have been administered a particular batch of a drug or that drug. The latter circumstances are applicable, for example, when there are multiple studies of that particular drug and the company deems it necessary to contact all patients who have received that drug without being limited to the particular study in which the enrollee participated. While being described above as being useful for conveying safety information, the information collected also can be used to all patients in the circumstances above to be contacted to request information. For example, it may be desirable to know if a particular event has ever occurred in any patient administered the drug in any clinical study. This implementation would allow all of those patients to be contacted.

In another implementation using the system described above, the system can be configured such that the enrollee can contact the company directly or indirectly while maintaining anonymity to provide information about an adverse event or to request information about the drug or clinical study. For example, the enrollee may have an adverse event and desire to know if there is any relationship between the adverse event and the drug used in the clinical study. In one embodiment, the enrollee merely uses an email address to contact the tracking organization and that contact is forwarded to the company. In another embodiment, the email address described above, 1234.XYZ@trackingorganziation.com, which includes at least a portion of the enrollee's identifier code, can be used by both the company and the enrollee to request information or provide information to the other entity. In this embodiment, the tracking organization functions as an email translator to take the email sent to 1234.XYZ@trackingorganziation.com, from either the company or the enrollee, and then send an email to the enrollee or company, respectively.

The system described in FIG. 5 demonstrates how the concepts described herein can be used to provide information to patients in a clinical study, or who were in a clinical study, while maintaining patient privacy. This is a one-way communication. FIG. 5 also demonstrates how these concepts can be applied to a two-way communication, for example, allowing the drug company to request information from the enrollee and allow the enrollee to respond while maintaining enrollee confidentiality from the drug company.

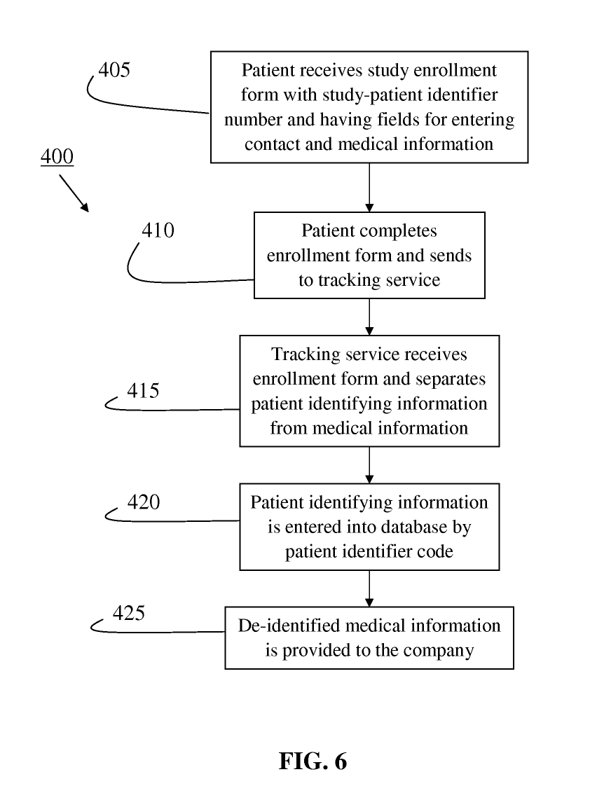

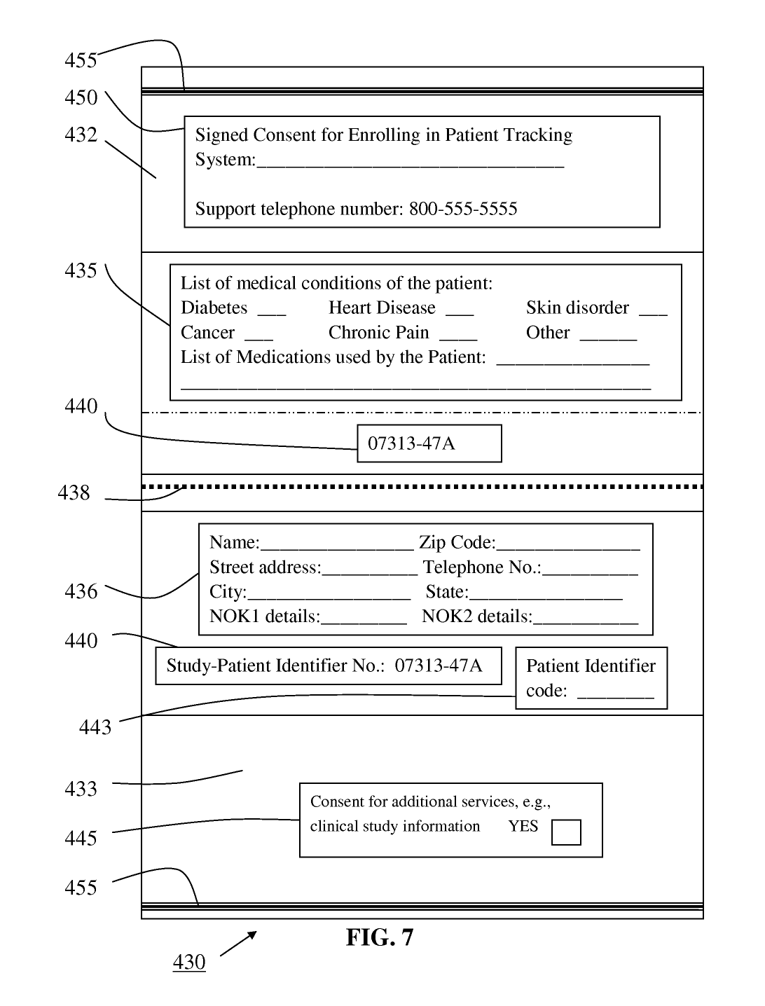

Referring to FIGS. 6 and 7, the concepts described herein can be used to allow the client company to obtain information at the time of enrollment in a study. As described above with respect to FIGS. 2 and 3, the enrollee only provided contact information. FIGS. 6 and 7, in contrast, demonstrate a process 400 by which the patient can provide contact information and medical information on the same form at the time of enrollment while still maintaining confidentiality from the company. Upon enrolling in the study the enrollee receives a study enrollment form 430 (step 405). The Patient study enrollment form has two parts, a remnant part 432 and a stub part 433. In general, the remnant part 432 contains medical information 435 about the enrollee and the stub part 433 contains contact or other identifying information 436 about the enrollee. During the process 400, the remnant part 432 and the stub part 433 are separated along a perforation 438. The remnant part and the stub part each contain the same study-patient identifier number 440. The stub part 433 additionally includes a patient identifier code 443. The code 443 can be as described above, a sequential number used to store the forms in the database and as hard copies. The stub part also may include a field 445 for allowing the enrollee to be contacted for purposes not strictly related to the clinical study. For example, the field 445 may request consent of the enrollee to be contacted about additional clinical studies.

The remnant part 432 also includes a consent field 450 to provide consent for the patient tracking service to enroll the patient in the service. The consent also may allow the service to use the data provided for additional purposes. The field also may include the telephone number of the patient tracking service for the patient to contact the service if the patient has any questions while completing the form.

Either or both of the stub part and the remnant part may include an adhesive seal 455 for sealing the form after it has been completed. The reverse side of the form (not shown) may include an address of the patient tracking service and prepaid postage for sending in the form. Thus, for the enrollee to completes and send in the form to the patient tracking service (step 410), the enrollee merely needs to remove the adhesive covering, seal the adhesive to the other side of the form, and drop it in a postal box so that the form can be delivered to the patient tracking service.

When the patient tracking service receives the form 430 they separate the remnant part 432 and the stub part 433 from each other, thereby separating the medical information 435 from the patient identifying information 436 (step 415). The patient tracking service then enters the data from the stub part 433 into a database (step 420) and either stores the stub part in a secure filing system or destroys the stub. The information from the stub part and the stub part itself may be stored based on the patient identifier code. The remnant part, which includes the medical information, is then sent to the company sponsoring the study or the company they have nominated to perform the data entry (step 425). The sponsor then has the medical information as well as the study-patient identifier number 440 but not any patient identifying information. The patient tracking service, in contrast, has the study-patient identifier, the patient identifying information, but not the medical information. Thus, the patient tracking service knows that the patient enrolled in the tracking service but does not know the medical reason for enrolling.

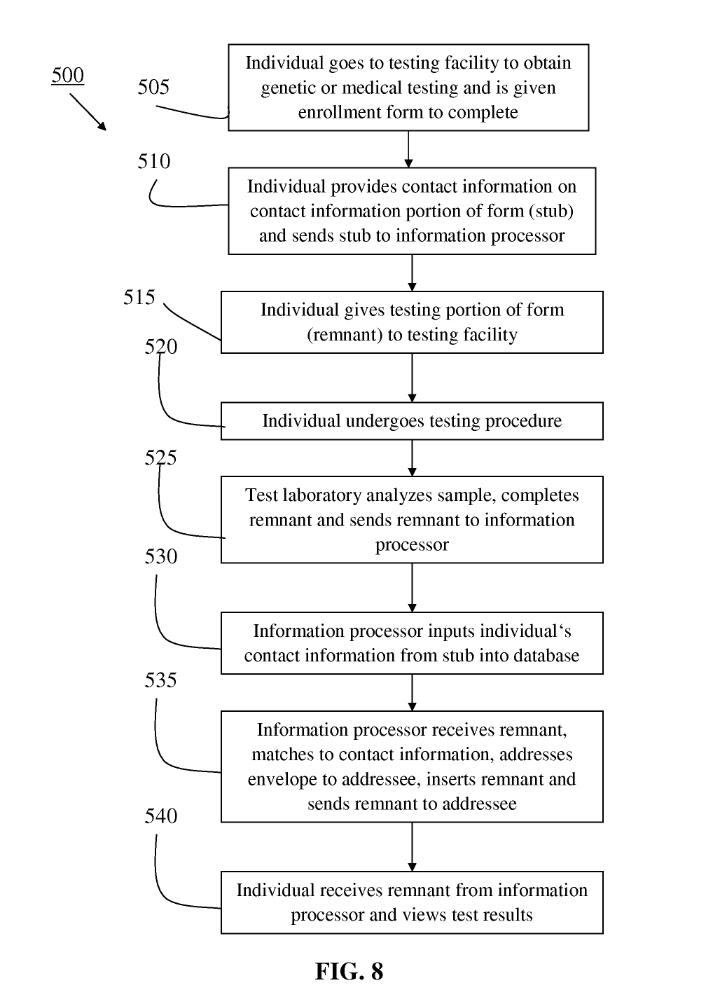

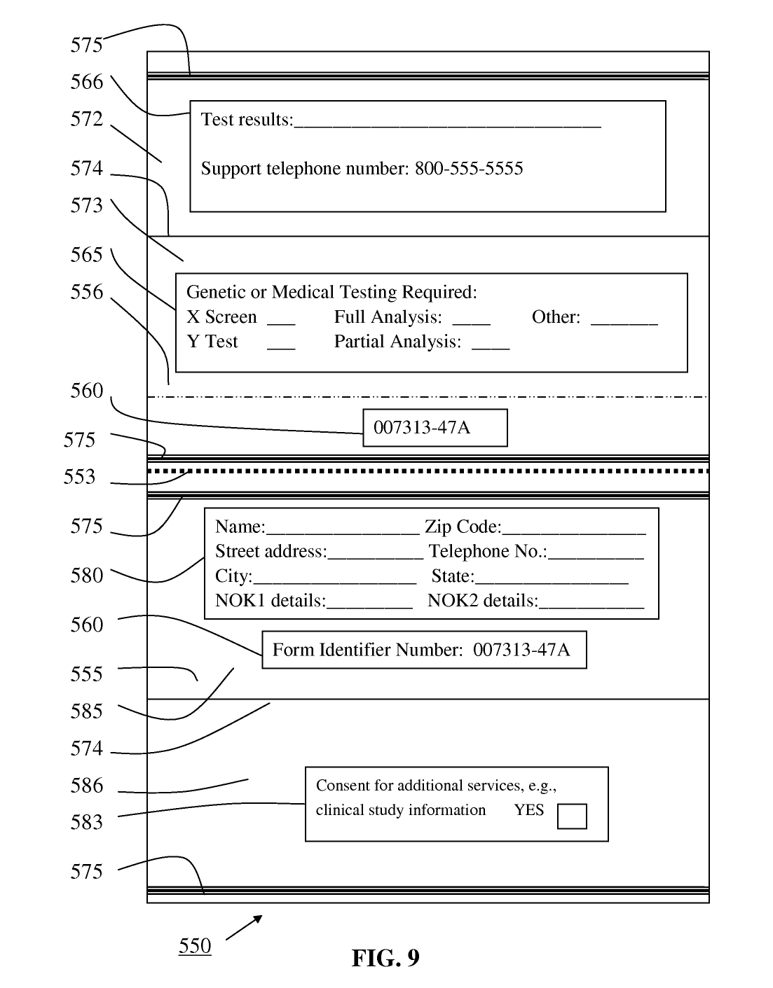

Referring to FIGS. 8-10, the systems described herein can be applied to requesting medical information, such as requesting genetic testing, to provide genetic testing privacy for individuals undergoing genetic testing as well as to medical testing in general to provide medical testing privacy for individuals undergoing medical and disease testing (e.g., AIDs testing, sexually transmitted disease testing, blood testing), and medical screening. In general, an individual can make a request for medical information with complete anonymity, such as by taking a medical test anonymously and obtaining the medical test results anonymously. The test results are sent anonymously to the individual while maintaining the anonymity of the individual. For example, people are concerned that their genetic testing results can or will be used at a later time to limit their ability to obtain insurance, employment, etc., if the testing indicates an increased risk of a particular condition, e.g., breast cancer, heart disease, ALS, etc. As a consequence, people hesitate to have genetic testing performed. This hesitation can be detrimental because awareness of an increased likelihood of getting a particular condition may cause an individual to make lifestyle changes relating to risk factors within their control such that they can reduce the likelihood of getting the condition.

Similarly, people are uncomfortable with having medical or blood testing performed if the results, were they to become public or known by others, would adversely impact their employment status, social status, ability to obtain insurance, etc. Thus people may hesitate to have their blood tested and will not know if they have they a transmissible disease or a condition that could be alleviated or improved if a treatment course was initiated.

The inventors believe that there is a need to give people the ability to obtain genetic and medical testing while alleviating their concern of a company or other individual holding their test results and name associated together. The individual may rightly or wrongly feel that their name and test results may become known to others, in particular, insurers or employers who may discriminate in hiring or insuring based on their genetic or medical results.

The inventors have developed a method for allowing an individual to make a request for medical information (e.g., medical testing) and obtain genetic, medical, and/or blood test results with only that individual having both (a) an individual's name (b) and that individual's test results. The method also can be used such that no one other than the individual himself/herself is aware that of the occurrence of the testing. In general, these methods rely on separating the holder of the test results from the holder of the name and contact information of the individual who has been tested.

In the basic implementation of FIGS. 8-10, there are three entities involved in the process: the individual, the testing laboratory that generates and holds the medical information, and the information processor. The testing laboratory and the information processor may arrange a partnership by which an individual who wishes to be tested by the testing company and goes to a testing laboratory will be provided a registration form 550 (step 505) that has two parts separated by a perforation 553: (1) patient identifying information to be completed by the individual (known as the stub part 555) and (2) test results fields to be completed by the testing laboratory (known as the remnant part 556). The form has a unique form identifying number 560 printed on both the stub part 555 and the remnant part 556 to allow both parts of the form to be related or tracked to each other. To obtain the form, the individual downloads the form over the Internet, is given the form by the information processor, or obtains the form at the testing laboratory. The individual completes the stub part and the remnant part of the form. The remnant part 556 includes two primary sections: the testing requirements section 565 and the test results section 566. The testing requirements section 565 is used by the person to specify the testing that they want performed. The test results section 566 is used by the testing laboratory to provide the test results, although the test results also can be provided on a separate document used in conjunction with the form 550 or the form identifier number 560. This section also can include contact information for the person to use if they have questions about the test results, need counseling, etc.

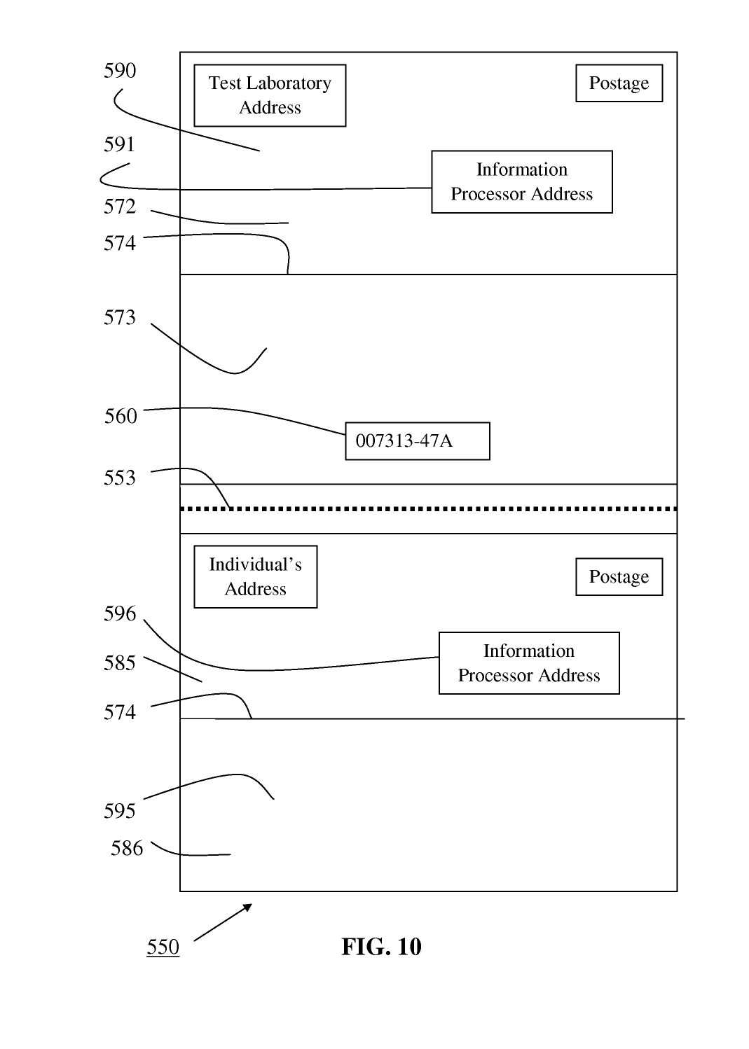

The remnant part 556 is divided into two physical halves 572, 573 such that the two halves can be folded along a fold line 574. One or more adherent layers 575 can be used to seal the two halves 572, 573. As illustrated in FIG. 10, which shows the reverse side of the form 550, the remnant part 556 has on its reverse side 590 the address 591 for the information processor. The testing laboratory address and a postal stamp also can be present on the reverse side. The remnant part 556 also includes the form identifier number 560 on one or the other side of the reverse side. In this manner, once sealed, the remnant part does not need to be opened by the information processor to determine who should receive the sealed form.

The stub part 555 includes a contact information section 580, the form identifier number 560 that is the same as or relates to the form identifier number on the remnant part 556, and an additional information section 583. The contact information can be limited to primary contact information (e.g., the contact information of the person only) or broader to include secondary contact information, such as next of kin. Because the form 550 is being used to transmit information or test results that the person considers to be highly confidential, it is unlikely that the secondary contact information will be provided. The additional information section 583 can, for example, include a box where the person consents to be contacted about enrolling in clinical studies and a listing of disease conditions for which they wish to be considered for a clinical study.

The stub part 555 is divided into two physical halves 585, 586 such that the two halves can be folded along a fold line 574. One or more adherent layers 575 can be used to seal the two halves 585, 586. As illustrated in FIG. 10, which shows the reverse side of the form 550, the stub part 555 has on its reverse side 595 the address 596 for the information processor. The return testing laboratory address and a postal stamp also can be present on the reverse side.

Referring to step 510, after completing the form 550 the person terms the stub part 555 from the remnant part 556 along the perforation 553. The person then seals the adherent layers 575 on the stub part and place the stub part in the mail to be sent to the information processor. Referring to step 515, the person then gives the remnant part 556 to the testing facility and undergoes the testing procedure, such as drawing a blood sample (step 520). The testing facility then processes the sample provided for the testing procedure, completes the remnant part 556, seals the adherent layers 575 and sends the remnant part to the information processor (step 525). As noted above, the sealed remnant part 556 will be sent having the form identifier number 560 on the outside. The laboratory may also send additional information relating to the test results, including explanations of the results, support groups to contact, a hotline to call, etc. The remnant and additional test information will be sent in a sealed manner such that the unique identifying number is displayed but none of the genetic testing information can be seen.

Referring to step 530, the information processor typically will receive the stub part 555 and input the contact information from it into a database and then either store or destroy the remnant part. Subsequently the information process will receive the remnant part 556. Upon receipt of the remnant part, the information processor looks at the form identifier number 560 on the outside of the remnant, matches the number to contact information in the database with that same form identifier number, prints out an address label for the person in the database associated with that form identifier number 560, places the address label on an envelope, inserts the unopened remnant part 556 into the addressed envelope, and sends the envelope to the addressee (step 535).

The addressee receives and opens the envelope, retrieves the remnant part from the envelope, opens the remnant part and views the test results (step 540). By following the process 500, when the addressee receives the envelope and opens it, it will be the first time that someone has the test results and the patient identifying information together.

As a further privacy precaution, before opening the remnant the addressee can verify that the remnant has not been opened. In this manner, the addressee can be sure that no one else knows of the test results and the identity of the person tested. The addressee also can verify that the form identifier number on the remnant part is the same on the stub part to ensure that the test results are for the correct person. For example, the stub part can further include a small strip with the form identifier number 560 also printed on it such that by removing and saving the strip, the person can later verify that they have received the correct test results.

It should be noted that the systems described herein rely upon entering information, such as contact information, into a database. One objective of the services provided herein is to maintain patient or enrollee privacy and anonymity. Thus, it is important that the information in the database be maintained in a secure manner. In one implementation of the systems described herein, the database is kept on an isolated server, namely, a server that has no connections to the Internet, either wired or wirelessly. For example, the database can be implemented on an isolated server that is wired to one or more keyboards and monitors but otherwise has no additional wired or wireless connections. The only communication the isolated server has is through its keyboards/monitors and periodic connection to a portable storage media.

The isolated server can be configured with software to facilitate sending outbound communications to enrollees. For example, the software can be set to provide a daily set of outbound communications to enrollees, investigators, or other individual otherwise registered in the database. The software can include preset text for the communication depending upon the type of communication. The software also can be programmed to read information from a portable storage media device to search for instructions for outbound communications and the like. Thus, on a daily basis an operator can connect any portable storage media such as a CD-RW, DVD or flash drive device to the isolated server, upload any outbound communication requests, allow the isolated server to process the outbound communications, and download that day's communications onto the portable storage media. The portable storage media then is physically removed from the isolated server and taken to an online server or computer that is connected to the Internet and uploaded to the online server or computer. The online server or computer is programmed with communications software that retrieves the communications from the portable storage media and performs a number of steps, depending upon the communications necessary.

As noted above, communications with the enrollees or alternative contact will be made by a number of means: postal mail, email, fax, telephone call, SMS, text message, etc. The communications software therefore can (1) cause letters and address labels to be printed for those to be contacted by postal mail, (2) send emails to enrollees who are to be contacted by email, (3) send faxes to those to be contacted by facsimile, (4) print out a listing of names and telephone numbers for a person to manually telephone, or (5) send out SMS and text messages, as the need may be. The information on the portable storage media then may be cleared or otherwise destroyed such that the information cannot be used for any other purpose. The printing of names and telephone numbers to manually telephone may be accompanied by an explanation of why each person is being contacted, e.g., annual confirmation of details, next of kin call, other communication, etc. The names and telephone numbers also can be separated into listings that categorize the nature of the call.

As one example of using the isolated server for an outbound communication, a company sponsoring a clinical study may wish to determine whether certain events have occurred in any patients enrolled in the clinical study or otherwise warn the patients of a safety concern. To obtain this information, the company sends an email to the patient tracking service with a list of study-patient numbers and the information to be sent. This listing then is transferred to from the online server and to the portable storage media. The portable storage media is removed from the online server or computer and connected to the isolated server, at which point the software on the isolated server reads the storage media and determines whether there are outbound communications to be generated. If there are outbound communications to be generated the software will retrieve names and addresses from the database that correlate to the study-patient numbers provided. The names and addresses will be used with the communication text, individualized messages prepared and stored on the storage media. The software then will download the other communications that need to be generated and sent. The operator then removes the storage media from the isolated server and physically connects the storage media to the online server or computer. The communications software on the online server or computer then retrieves the information from the storage media and either generates and sends or merely sends the communications to the appropriate individuals.

The isolated server also can be applied to the medical testing described above. When a remnant is received from the testing laboratory, the operator at the tracking services inputs the form identifying number 560 into the online computer and that number is uploaded to the portable storage media. When the portable storage media is connected to the isolated server, the form identifying number 560 is used to retrieve a name and address, and that name and address is placed on the portable storage media. When the portable storage media is once again connected to the online computer, the communications software will cause a mailing label or preprinted envelope to be generated for forwarding on the test results.

The systems using the isolated server and the online server or computer also can be applied to the systems described herein but with the use of an online-based registration or enrollment system. For example, an individual wishing to enroll in the patient tracking system can go to a secure web site, enter their contact information and study-patient number and submit the information to the patient tracking service. Upon receipt of that information by the tracking service, the information can be printed out and the electronic data destroyed. With the print out, the service can process the information in the same manner as if the print out was a form that had been completed by hand and mailed in. It should be understood that these same types of modifications can be applied to the other types of communications with or by the patient tracking service.

While several particular forms of the patient tracking, contacting, and testing systems have been illustrated and described herein, it will be apparent that various modifications and combinations of the inventions detailed in the text and drawings can be made without departing from the spirit and scope of the inventions. For example, the patient tracking systems described herein for the genetic testing system can be equally applied to medical testing for conditions such as HIV, sexually transmitted diseases, etc. The information transferred in these processes can be transferred by mailing, faxing, communicating over the Internet, etc. so long as the information is kept confidential. Accordingly, it is not intended that the inventions be limited, except as by the appended claims and other embodiments are within the scope of the following claims.

We claim:

1. A method for maintaining the contact information of an enrollee in a clinical study while maintaining the anonymity of the enrollee from the clinical study sponsor, the method comprising:
obtaining contact information for the enrollee in the clinical study;
entering the contact information into a database;
using a contact cascade on a scheduled, periodic basis to contact the enrollee using the contact information from the database to ensure that the contact information is correct; and
updating the contact information if a contact is made with the enrollee and the contact information needs to be updated to be accurate.

2. The method of claim 1, wherein the contact information obtained comprises primary contact information and secondary contact information.

3. The method of claim 2, wherein the secondary contact information comprises one or more of contact information for friends, friends who do not live with the enrollee, relative, relatives who do not live with the enrollee, membership in organizations, and an authorization form to contact another entity for information about the enrollee.

4. The method of claim 1, further comprising providing a study-patient identifier number for each enrollee and entering the study-patient identifier number into the database.

5. The method of claim 1, wherein obtaining contact information for the enrollee in the clinical study comprises providing a form comprising:
a section for providing contact information for the enrollee; and
at least one placement on the form of a study-patient identifier number.

6. The method of claim 5, wherein the form comprises one or both of a web page for inputting the contact information, an email having a web link, and an email having fields for completing and sending back to the sender.

7. The method of claim 1, wherein the database is maintained on an isolated server.

8. The method of claim 7, wherein contacting the enrollee comprises retrieving the contact information from the database using a portable storage media, transferring the contact information from the portable storage media to an online computer, and using software to contact the enrollee.

9. The method of claim 8, wherein using software to contact the enrollee comprises one or more of sending emails to the enrollee, sending text or SMS messages to the enrollee, printing letters and/or mailing addresses to the enrollee, and printing lists of enrollees and telephone numbers for telephoning the enrollees.

10. The method of claim 1, wherein the communication cascade comprises a sequence of one or more of emails, facsimiles, telephone calls, letters, and text or SMS messages.

11. The method of claim 10, wherein the communication cascade is first directed to the primary contact information and then to the secondary contact information.

12. The method of claim 4, further comprising providing a means whereby a sponsor of a clinical study can contact the enrollee or direct a contact to the enrollee while maintaining the anonymity of the enrollee with respect to the sponsor.

13. The method of claim 12, wherein contacting the enrollee may include contacting the enrollee by using the study-patient identifier number.

14. The method of claim 13, wherein contacting the enrollee by using the study-patient identifier number comprises sending an email that includes at least a portion of the study patient identifier number.

15. The method of claim 14, wherein contacting the enrollee by using the study-patient identifier number comprises using a field on a website that includes the study-patient identifier number to contact the enrollee.

16. The method of 1, wherein the anonymity of the enrollee from the clinical study sponsor is maintained when contacting the enrollee.

17. The method of claim 1, wherein the contact information of all of the enrollees in the clinical study are maintained in anonymity from the clinical study sponsor.

18. The method of claim 1, further comprising providing a means for the enrollee to communicate to the clinical study sponsor.

19. The method of claim 18, further comprising providing a means for the enrollee to communicate to the clinical study sponsor in response to a communication from the clinical study sponsor.

20. The method of claim 18, wherein the means of communication comprises one or more of a web link, a web page, a text or SMS message, a document, and an email.

21. A form for using in a clinical study to collect contact information of an enrollee in the clinical study, the form comprising a first section for providing contact information, a second section for placement of a study-patient identifier number and a third section for placement of an address of a patient tracking service for sending the form to the patient tracking service.

22. A method for communicating medical information relating to a person while preventing the holder of the medical information from having the patient identifying information with the patient's medical information, the method comprising:
providing a medical information request form that does not include patient identifying information but includes a patient identifier number;
providing a means for providing the patient identifying information, wherein the means includes the patient identifier number;
inputting the patient identifying information that is provided into a database;
using the patient identifier number to retrieve the patient identifying information from the database; and
using the patient identifying information retrieved from the database to send the patient medical information to the patient.

23. The method of claim 22, wherein the medical information request form comprises a listing of medical information required and the patient identifier number.

24. The method of claim 22 wherein the means for providing the patient identifying information comprises a form having the patient identifier number and a section for providing the patient identifying information.

25. The method of claim 22, wherein the medical information request form and the means for providing the patient identifying information are provided together.

26. The method of claim 22, wherein the medical information request form and the means for providing the patient identifying information are provided as a single form.

27. The method of claim 22, wherein the medical information request form comprises requests for at least one test to be performed.

28. The method of claim 27, wherein the test to be performed comprises one or more of a genetic test, a medical test, a disease test, or a screening.

29. A form for requesting a medical test, the form comprising:
a first section for specifying a request for medical information;
a second section for providing patient identifying information; and
at least one patient identifier number placed on the form associated with either the first section for specifying the request for medical information or the second section for providing patient identifying information.

30. The form of claim 29, further comprising a second placement of the patient identifier number on the form, wherein at least one patient identifier number placed on the form is associated with the first section for specifying the request for medical information and at least one patient identifier number placed on the form is associated with the second section for providing patient identifying information.

31. The form of claim 29, wherein the form comprises two unconnected parts,
the first part comprising the first section for specifying a request for medical information and at least one patient identifier number; and
the second part comprising the second section for providing patient identifying information and at least one patient identifier number.

32. The form of claim 31, wherein the two parts become unconnected by tearing a perforation formed between the two parts.
